(19) United States
(12) Patent Application Publication
(10) Pub. No.: US 2013/0143285 A1
(43) Pub. Date: Jun. 6, 2013

(54) METHOD FOR DILUTE ACID PRETREATMENT OF LIGNOCELLULOSIC FEEDSTOCKS

(71) Applicants: Jeffrey S. Tolan, Ottawa (CA); Steven Cardile, Ottawa (CA); Daphne Wahnon, Ottawa (CA)

(72) Inventors: Jeffrey S. Tolan, Ottawa (CA); Steven Cardile, Ottawa (CA); Daphne Wahnon, Ottawa (CA)

(73) Assignee: IOGEN ENERGY CORPORATION, Ottawa, ON (CA)

(21) Appl. No.: 13/816,270

(22) PCT Filed: Aug. 11, 2011
(86) PCT No.: PCT/CA2011/050490

§ 371 Date: Feb. 11, 2013

Related U.S. Application Data
(60) Provisional application No. 61/372,496, filed on Aug. 11, 2010.

(51) Int. Cl. C08B 1/00

(52) U.S. Cl. CPC C08B 1/00
USPC 435/136; 435/155; 435/158; 127/34

(57) ABSTRACT

The present invention relates to a process for the conversion of a lignocellulosic feedstock involving acid pretreatment. The process comprises the steps of treating the lignocellulosic feedstock with alkali at a pH of between about 8.0 and about 12.0 so as to dissolve acetyl groups present on said lignocellulosic feedstock, while converting less than about 10% of the xylan present in the lignocellulosic feedstock to xylose and less than about 10% of the cellulose to glucose, thereby producing an alkali conditioned feedstock. The alkali conditioned feedstock is then pretreated at a temperature of about 160° C. to about 250° C., at a pH of about 0.5 to about 2.5 for about 0.5 to about 10 minutes so as to hydrolyze about 80 to 100% of the xylan and about 3 to about 15% of the cellulose to produce an acid pretreated feedstock comprising cellulose. The cellulose in the pretreated feedstock can be hydrolyzed to glucose with cellulase and the glucose can be fermented to produce a fermentation product.

### FIELD OF INVENTION

The present invention relates to a method for the processing of lignocellulosic feedstocks to produce sugar. More specifically, the present invention relates to a method of processing lignocellulosic feedstocks using a step of acidic pretreatment.

### BACKGROUND OF THE INVENTION

In recent years there has been an increasing interest in generating ethanol and fine chemicals from lignocellulosic feedstocks. These feedstocks are of particular interest as they are inexpensive and are often burned or landfilled. Accordingly, there is an enormous untapped potential for their use as a source of fermentable sugar to produce ethanol or other byproducts. The fermentable sugar is produced from the polysaccharide components of the feedstock, namely cellulose which makes up 30% to 50% of most of the key feedstocks, and hemicellulose (mainly xylan) which is present at 15% to 30% in most feedstocks. The remaining components of lignocellulosic feedstock include lignin, which is typically present at 15-30%, ash, protein and starch.

In order to produce fermentable sugar from lignocellulosic feedstocks, it is first necessary to break the polysaccharides down into their composite sugar molecules. One particularly suitable method for accomplishing this is by chemical pretreatment to hydrolyze xylan, followed by hydrolysis of the cellulose to glucose, for example, by cellulase enzymes. An example of a chemical pretreatment is acid pretreatment with steam, although alkali has been proposed for such purpose as well.

In one type of acid pretreatment process, the pressure produced by the steam is brought down rapidly with explosive decompression, which is known as steam explosion. Foody (U.S. Pat. No. 4,461,648) describes the equipment and conditions used in steam explosion pretreatment. Steam explosion with sulfuric acid added to achieve a pH of 0.4 to 2 has been the standard pretreatment process for two decades as it produces pretreated material that is uniform and requires less cellulase enzyme to hydrolyze cellulose than other pretreatment processes.

After enzymatic hydrolysis, glucose can be fermented to fuels including ethanol and butanol or other chemicals such as sugar alcohols and organic acids. The pentose sugars, xylose and arabinose, can also be fermented to ethanol by recombinant yeast (see U.S. Pat. No. 5,789,210 (Ho et al.), U.S. Pat. No. 5,126,266 (Jeffries et al.), WO 2008/130603 (Abbas et al.) and WO 03/095627 (Boles and Becker)) or by bacteria. Moreover, the production of xylitol from xylose has received much attention because of its value as a substitute sugar sweetener. This latter fermentation can be accomplished by yeast, such as Candida tropicalis or by chemical hydrogenation.

One drawback of using lignocellulosic feedstock to make sugar is that the sugar streams often contain acetic acid, which has been identified by various groups as an inhibitor of both cellulase enzymes and the yeast used in the subsequent fermentation. The acetic acid originates from acetyl groups present on the xylan component of the feedstock and is liberated therefrom during acid pretreatment or by alkali pretreatment.

Lime pretreatment has been proposed as a method to remove acetic acid so as to improve the enzymatic hydrolysis of cellulose. Chang et al. (Applied Biochemistry and Biotechnology, 1998, 74:135-159) examined the effects of different lime pretreatment conditions (time, temperature, lime loading, water loading and biomass particle size) on the enzyme digestibility of bagasse and wheat straw with a cellulase enzyme preparation. The investigators found that that for short pretreatment times (1-3 hrs), high temperatures (85-135° C.) were required to achieve high sugar yields, whereas for long pretreatment times (e.g., 24 hrs), low temperatures (50-65° C.) were effective. The digestibility of the lime pretreated feedstock increased only slightly at lime loadings of greater than 0.1 Ca(OH)₂/g dry biomass and it was suggested that these observations were consistent with the hypothesis that the biomass digestibility is significantly enhanced by removing acetyl groups from xylan and that when enough lime is added to remove acetate, further lime addition is not beneficial.

Kong et al. (Applied Biochemistry and Biotechnology, 1992, 34/35:23-35) reported that selective deacetylation of aspen wood with potassium hydroxide improved a subsequent enzymatic hydrolysis using an enzyme mixture containing cellulase and hemicellulase enzyme components.

Pan et al. (Holzforschung, 2006, 60:398-401) showed that the removal of acetic acid from pulp derived from various wood species improved the hydrolysis of cellulose with cellulase enzymes. Removal of the acetyl groups was effected by treatment with 1% sodium hydroxide at 50° C. for 2 hours.

Grohmann et al. (Applied Biochemistry and Biotechnology, 1989, 20/21:45-61) deacetylated aspen wood and wheat straw with hydroxylamine, followed by enzymatic hydrolysis with a cellulase enzyme mixture containing xylanase activity (NOVO Celluclast 1.5 L/Novozym SP188 cellulase/13-glucosidase). Removal of the acetyl groups improved the extent of digestion of both cellulose and xylan by the enzymes.

Chang and Holtzapple (Applied Biochemistry and Biotechnology, 2000, 84-86:5-37) examined the effects of acetic acid and lignin removal, as well as crystallinity on the digestibility of poplar wood by cellulase enzymes. Peracetic acid, potassium hydroxide and ball milling were used to remove lignin and acetic acid and reduce the crystallinity of the feedstock, respectively. With regard to the hydrolysis of cellulose with cellulase enzymes, it was found that lignin content and crystallinity of the feedstock had the greatest impact on enzyme digestibility, whereas acetyl removal had a minor impact. Nonetheless, it was suggested that acetyl removal would have a more significant effect on the enzyme digestibility of xylan.

Another factor that has reduced the economic feasibility of acid pretreatment processes is that the pretreatment reactor and downstream process equipment, such as flash tanks, are exposed to the acidic feedstock, which is typically at a pH of about 0.4 to 2.0 (see WO 2006/128304; Foody and Tolan). This requires the use of expensive acid-resistant materials on the process equipment exposed to feedstock at these low pH values. Furthermore, the sugars present in the pretreated feedstock (mainly xylose, glucose and arabinose) degrade under acidic conditions, especially in the localized areas of low pH that can be present in the feedstock.

Cao et al. (Biotechnology Letters, 1996, 18(9):1013-1018) disclose a method of steeping corn cobs with 2.9 M ammonium hydroxide for 24 hours at 26° C., which removed 80-90% of the lignin along with almost all the acetate from the feedstock. The corn cobs were then subjected to pretreatment with 0.3 M hydrochloric acid (pH 0.5) at 100-108° C. for one hour to produce a cellulose-containing residue. It was reported that enzymatic hydrolysis of the cellulose residue by cellulase enzymes and subsequent fermentations were improved as a result of the steeping treatment. Similar processes employing an initial step of ammonia steeping, followed by HCl pretreatment and enzymatic hydrolysis were conducted by Chen et al., Biomass and Bioenergy, 2009, 33:1381-1385 and Spigno et al., Bioresource Technology, 2008, 99:4329-4337, but used different feedstocks, namely corn stover and grape stalks respectively. In another study, Cao et al. (Applied Biochemistry and Biotechnology, 1997, 63-65:129-139) treated corn cobs under the same conditions described previously, (Cao et al., 1996, supra) but fermented both hexoses and pentoses to 2,3-butanediol rather than ethanol.

A drawback of the foregoing method utilized by Cao et al. (1996 and 1997), Chen et al and Spigno et al. (supra) is that hydrochloric acid, which was used in the pretreatment, is not a desirable acid for pretreatment due to its corrosive effect on the metallurgy of process equipment. This effect would be exacerbated at the low pH of 0.5 that was utilized in the pretreatment.

A further limitation of acid pretreatment utilized to date is that the kinetics of xylan hydrolysis is biphasic, meaning that the xylan contains a fast hydrolysable component and a component that has proven to be quite difficult to hydrolyze (see U.S. Pat. No. 5,125,977 and Maloney et al., Biotechnology and Bioengineering, 1985, XXVII:355-361). The reason for these differential rates of xylan hydrolysis has not been elucidated. However, the hydrolysis of the slow hydrolysable component, which can account for 30% of the xylan, can significantly increase the time required for the pretreatment, and thus is a further factor limiting the economical feasibility of pretreatment.

U.S. Pat. No. 5,125,977 (supra) discloses a two-stage dilute acid prehydrolysis in which xylan that is fast hydrolysable is first hydrolyzed under low temperature conditions and then xylan that is more slowly hydrolysable under higher temperature conditions. The two steps are run with different acid concentrations and different residence times, with the second treatment being harsher than the first. That is, the method still requires harsh pretreatment conditions in the second stage and thus is subject to the disadvantages described previously.

U.S. Pat. Nos. 4,137,395, 4,072,538, 3,990,904, 4,105,467, 3,970,712, 3,954,497 and 3,565,687 disclose a two-stage decomposition of hemicelluloses of xylan-containing materials for the purpose of obtaining xylose. According to the process, in the first stage, feedstocks containing xylan are brought into contact with an alkali hydroxide solution or other suitable alkali to remove acetyl groups and the residue is conveyed into a subsequent extraction zone where it is extracted. In this subsequent extraction zone, residue of the first stage is brought into contact with dilute acid to hydrolyze the xylan to xylose.

Despite these efforts, there is a need for more efficient and cost effective processes for converting lignocellulosic feedstock to sugar, which in turn can be fermented to produce a fermentation product having commercial use. In particular, there is a need in the art to further reduce capital and operating costs associated with such a process so as to make it commercially viable.

### SUMMARY OF THE INVENTION

The present invention overcomes several disadvantages of the prior art by taking into account the difficulties encountered in steps carried out during the processing of cellulosic feedstock to obtain fermentable sugar.

It is an object of the invention to provide an improved method for pretreating a lignocellulosic feedstock.

The present invention is based on the discovery that by removing acetyl groups from the feedstock with alkali prior to acid pretreatment, the conditions of the acid pretreatment can be milder than those one would select in the absence of such alkaline conditioning.

According to a first aspect of the present invention, there is provided a process for the conversion of a lignocellulosic feedstock to a fermentation product, the process comprising the steps of: (i) treating the lignocellulosic feedstock with alkali at a pH of between about 8.0 and about 12.0 so as to dissolve acetyl groups present on the lignocellulosic feedstock, while converting less than about 10% of the xylan present in the lignocellulosic feedstock to xylose and less than about 10% of the cellulose to glucose, thereby producing an alkali conditioned feedstock; (ii) pretreating the alkali conditioned feedstock with acid at a temperature of about 160° C. to about 250° C., at a pH of about 0.5 to about 2.5 for about 0.5 to about 10 minutes so as to hydrolyze about 80 to 100% of the xylan and about 3 to about 15% of the cellulose to produce an acid pretreated feedstock comprising cellulose; (iii) adding cellulase enzymes to the acid pretreated feedstock to hydrolyze the cellulose to glucose; and (iv) fermenting the glucose to the fermentation product.

According to a second aspect of the invention, there is provided a process for producing a pretreated lignocellulosic feedstock, the process comprising the steps of: (i) treating the lignocellulosic feedstock with alkali at a pH of between about 8.0 and about 12.0 so as to dissolve acetyl groups present on said lignocellulosic feedstock, while converting less than about 10% of the xylan present in the lignocellulosic feedstock to xylose and less than about 10% of the cellulose to glucose, thereby producing an alkali conditioned feedstock; and (ii) pretreating the alkali conditioned feedstock to produce the pretreated lignocellulosic feedstock at combinations of pH and t* bounded by a region in a semi-log plot of t* versus pH, which bounded region has four vertices with numerical values of: pH=0.5, t*=11 sec; pH=0.5, t*=16 sec; pH=2.5, t*=257 sec; and pH=2.5, t*=380 sec, which vertices are connected by straight lines and wherein t*=t×2^{(T-200)/13.9}, t=kinetic time (seconds), t=actual pretreatment time (seconds) and T=temperature, ° C.

According to one embodiment of this aspect of the invention, the vertices have numerical values of pH=0.5, t*=11 sec; pH=0.5, t*=14 sec; pH=2.5, t*=257 sec; and pH=2.5, t*=330 sec. In a further embodiment of the invention, the vertices have numerical values of pH=1.5, t*=50 sec; pH=1.5, t*=90 sec; pH=2.5, t*=257 sec; and pH=2.5, t*=330 sec.

According to an embodiment of any of the foregoing aspects of the invention, the temperature of the feedstock during the step of treating with alkali is between about 70° C. and about 120° C. In a further embodiment of the invention, the duration of the step of treating with alkali is between about 5 minutes and about 90 minutes. In another embodiment of the invention, less than about 25% of the lignin (w/w) is dissolved during the step of treating with alkali.

Optionally, the process of the present invention comprises a step of washing the conditioned feedstock with water to produce a washed, conditioned feedstock.

The acid used in the pretreating may be sulfuric acid, sulfurous acid, sulfur dioxide or a combination thereof.

According to a further embodiment of the invention, the fermentation product is ethanol.

According to a third aspect of the invention, there is provided a process for producing an acid pretreated lignocellulosic feedstock comprising cellulose, the process comprising the steps of: (i) treating the lignocellulosic feedstock with alkali at a pH of between about 8.0 and about 12.0, at a temperature of about 70° C. to about 120° C. and for a time period of between about 5 minutes and about 90 minutes so as to dissolve acetyl groups present on said lignocellulosic feedstock, while converting less than about 10% of the xylan present in the lignocellulosic feedstock to xylose and less than about 10% of the cellulose to glucose, thereby producing an alkali conditioned feedstock; and (ii) pretreating the alkali conditioned feedstock with acid at a temperature of about 160° C. to about 220° C., at a pH of about 1.5 to about 2.5 for about 0.5 to about 10 minutes so as to hydrolyze about 80 to 100% of the xylan and about 3 to about 15% of the cellulose to produce the acid pretreated feedstock comprising cellulose.

According to a fourth aspect of the invention, there is provided a process for producing an acid pretreated lignocellulosic feedstock, the process comprising the steps of: (i) leaching the lignocellulosic feedstock with an aqueous solution to remove at least potassium salts from said lignocellulosic feedstock and without significantly hydrolyzing xylan and cellulose, thereby producing a leached feedstock and leachate; (ii) removing the leachate from leached feedstock, said leachate comprising at least potassium salt; (iii) concentrating the leachate comprising the potassium salt to produce concentrated leachate; (iv) treating the lignocellulosic feedstock with alkali comprising concentrated leachate at a pH of between about 8.0 and about 12.0 so as to dissolve acetyl groups present on said lignocellulosic feedstock, while converting less than about 10% of the xylan present in the lignocellulosic feedstock to xylose and less than about 10% of the cellulose to glucose, thereby producing an alkali conditioned feedstock; and (v) pretreating the alkali conditioned feedstock with acid at a temperature of about 160° C. to about 250° C., at a pH of about 0.5 to about 2.5 for about 0.5 to about 10 minutes so as to hydrolyze about 80 to 100% of the xylan and about 3 to about 15% of the cellulose to produce the acid pretreated feedstock.

By carrying out the alkaline conditioning prior to pretreatment, it is possible to use a lower pretreatment temperature, a higher pretreatment pH, a shorter pretreatment time, or a combination of these. This can enable savings in acid and base use and salt processing, capital for the pretreatment reactor and high pressure steam systems, and decreased reactor corrosion.

By enabling such a mild acid pretreatment, it is possible that the use of specialized acid-resistant reactors can be avoided, which, in turn, can significantly reduce the cost associated with the process.

Without wishing to be bound by any particular theory, the Applicants believe that the acetyl groups bound to xylan are the cause of the slow acid-hydrolysable component of the xylan and that the lower temperature and acid requirements of the acid pretreatment are due to their removal.

Other advantageous features, at least according to embodiments of the invention, include improved fermentation due to the removal of acetic acid from process streams.

These and other features of the invention will become more apparent from the following description in which reference is made to the appended drawings.

### BRIEF DESCRIPTION OF THE DRAWINGS

FIG. 1 compares acid pretreatment conditions for conventional feedstock and feedstock that has been conditioned with alkali in accordance with an embodiment of the invention.

FIG. 2 shows pH and kinetic time ranges of pretreatment following alkaline conditioning in accordance with an embodiment of the invention.

FIG. 3 shows xylan solubilization, measured as final xylan content (over initial (Co), as a function of time, for raw and pH 10 alkali conditioned wheat straw.

FIG. 4 shows xylan solubilization, measured as final xylan content (C) over initial (Co), as a function of time, for raw and pH 12 alkali conditioned wheat straw.

FIG. 5 shows a laboratory-scale enzymatic hydrolysis of alkaline conditioned, pretreated wheat straw with cellulase enzymes at doses of 5.3 (diamonds), 15.1 (triangles) and 31.3 (squares) mg protein per gram cellulose. The undissolved solids concentration is 7.79%, the initial glucose concentration is 4.19 g/L and the cellulose concentration is 594 mg per g solids.

FIG. 6 shows a large-scale enzymatic hydrolysis (700 L) of alkaline conditioned, pretreated wheat straw with cellulase enzymes at a dose of 15 mg protein per gram cellulose.

### DETAILED DESCRIPTION

The following description is of a preferred embodiment by way of example only and without limitation to the combination of features necessary for carrying the invention into effect. The headings provided are not meant to be limiting of the various embodiments of the invention. Terms such as “comprises”, “comprising”, “comprise”, “includes”, “including” and “include” are not meant to be limiting. In addition, the use of the singular includes the plural, and “or” means “and/or” unless otherwise stated. Unless otherwise defined herein, all technical and scientific terms used herein have the same meaning as commonly understood by one of ordinary skill in the art.

### Feedstocks and Particle Size Reduction

The feedstock for the process is a lignocellulosic feedstock. By the term “lignocellulosic feedstock”, it is meant any type of plant biomass such as, but not limited to, non-woody plant biomass, cultivated crops such as, but not limited to grasses, for example, but not limited to, C4 grasses, such as switch grass, cord grass, rye grass, miscanthus, reed canary grass, or a combination thereof, sugar processing residues, for example, but not limited to, baggase, such as sugar cane bagasse, beet pulp, or a combination thereof, agricultural residues, for example, but not limited to, soybean stover, corn stover, rice straw, sugar cane straw, rice hulls, barley straw, corn cobs, wheat straw, canola straw, oat straw, oat hulls, corn fiber, or a combination thereof, forestry biomass for example, but not limited to, recycled wood pulp fiber, sawdust, hardwood, for example aspen wood, softwood, or a combination thereof. Furthermore, the lignocellulosic feedstock may comprise cellulosic waste material or forestry waste materials such as, but not limited to, newsprint, cardboard and the like. Lignocellulosic feedstock may comprise one species of fiber or, alternatively, lignocellulosic feedstock may comprise a mixture of fibers that originate from different lignocellulosic feedstocks. In addition, the lignocellulosic feedstock may comprise fresh lignocellulosic feedstock, partially dried lignocellulosic feedstock, fully dried lignocellulosic feedstock, or a combination thereof. Moreover, new lignocellulosic feedstock varieties may be produced from any of those species listed above by plant breeding or by genetic engineering.

Lignocellulosic feedstocks comprise cellulose in an amount greater than about 20%, more preferably greater than about 30%, more preferably greater than about 40% (w/w). For example, the lignocellulosic material may comprise from about 20% to about 50% (w/w) cellulose, or any amount therebetween. Furthermore, the lignocellulosic feedstock comprises lignin in an amount greater than about 10%, more typically in an amount greater than about 15% (w/w). The lignocellulosic feedstock may also comprise small amounts of sucrose, fructose and starch.

Lignocellulosic feedstocks of particle size less than about 6 inches may not require size reduction prior to or during leaching. That is, such feedstocks may simply be slurried in water and subjected to leaching. For feedstocks of larger particle sizes, the lignocellulosic feedstock is subjected to size reduction by methods including, but not limited to, milling, grinding, agitation, shredding, compression/expansion, or other types of mechanical action. The lignocellulosic feedstock is first subjected to size reduction by methods including, but not limited to, milling, grinding, agitation, shredding, compression/expansion, or other types of mechanical action. Size reduction by mechanical action can be performed by any type of equipment adapted for the purpose, for example, but not limited to, hammer mills, tub-grinders, roll presses, refiners and hydrapulpers. At least 90% by weight of the particles produced from the size reduction may have a length less than between about 1/16 and about 6 in. The preferable equipment for the particle size reduction is a hammer mill, a refiner or a roll press as disclosed in WO 2006/026863, which is incorporated herein by reference. Subsequent to size reduction, the feedstock is typically slurried in water. This allows the feedstock to be pumped.

### Leaching of the Lignocellulosic Feedstock and Obtaining Concentrated Leachate

The lignocellulosic feedstock contains leachable minerals, such as potassium, sodium, calcium and, in some instances, magnesium. The feedstock is optionally leached prior to dilute acid pretreatment to remove these substances from the feedstock. By leaching the lignocellulosic feedstock, the level of compounds that increase acid demand during dilute acid pretreatment is reduced.

Moreover, the leachate obtained from leaching of the feedstock has an alkaline pH due to the presence of basic minerals. Advantageously, as discussed hereinafter, the leachate may be concentrated and then used to increase the pH of the lignocellulosic feedstock during alkaline conditioning, thereby reducing the alkali demand during this step.

By the term “leached feedstock”, it is meant a lignocellulosic feedstock that has been in contact with an aqueous solution to remove at least potassium. In one exemplary embodiment of the invention, at least 75% of the potassium is removed from the feedstock during leaching. In another embodiment of the invention, at least 80% of the potassium, or at least 85% of the potassium is removed from the lignocellulosic feedstock during leaching. This includes all ranges therebetween, such as ranges containing numerical limits of 75, 80, 85, 90, 95 or 100%.

Optionally, sodium, a portion of calcium and a portion of magnesium, if present in the feedstock, are removed as well. The pH, temperature and duration of the leaching are selected so that limited hydrolysis of the xylan and cellulose in the feedstock occurs.

Leaching is conducted “without significantly hydrolyzing xylan and cellulose”. In this context, “without significantly hydrolyzing”, means that less than 5 wt % of the xylan and cellulose is hydrolyzed to oligomers, sugar monomers, or a combination thereof. Preferably less than 2 wt % of the xylan and cellulose is hydrolyzed. Acetyl groups present on the lignocellulosic feedstock will typically remain largely intact during the leaching step.

Leaching may comprise contacting lignocellulosic feedstock with an aqueous solution for a period between about 2 minutes and about 5 hours, or any amount therebetween, between about 2 minutes and about 4 hours, between about 2 minutes and about 3 hours, between about 2 minutes and about 2 hours or between about 10 minutes and about 30 minutes. Leaching may be performed at a temperature between about 4° C. and about 95° C., or any temeperature therebetween, or between about 20° C. and about 80° C., or between about 20° C. and about 60° C. Alternatively, the leaching may be performed at higher temperatures than this and under pressure, for example at temperatures greater than 95° C.

The aqueous solution used to leach the feedstock may have a pH between about 6 and about 9, or any pH therebetween. More acidic solutions used to leach the feedstock will remove diavalent cations, such as calcium and magnesium. The aqueous solution used for leaching may be water, process water, fresh water, or a combination thereof. On the other hand, solutions that are mildly acidic, neutral or mildly alkaline may leave most or all of the calcium and magnesium in the feedstock intact, but remove all or a majority of the potassium and sodium from the feedstock. The pH of the aqueous solution may be adjusted using small amounts of any suitable alkali, such as sodium hydroxide. Without being limiting the pH of the aqueous solution used to leach the lignocellulosic feedstock may fall within a range having numerical limits of about 6.0, 6.5, 7.0, 7.5, 8.0, 8.5 or 9.0, or any pH therebetween.

Leachate may be removed from the leached feedstock by any suitable solids-liquid separation such as pressing, washing, centrifugation, microfiltration, plate and frame filtration, crossflow filtration, pressure filtration, vacuum filtration and the like. As would be evident to those of skill in the art, the step of removing leachate from the leached feedstock need not result in complete removal of all aqueous solution from the leached feedstock.

The leaching step may be a batch or a continuous process. If the leaching is a continuous operation, it may be conducted co-current or counter-current.

In one exemplary embodiment of the invention, the leaching contains multiple stages with co-current and/or counter-current contact of liquids and solids. The leaching of the present invention may involve submerging the feedstock in a leaching bath for a predetermined amount of time. This step may be conducted in a tank adapted for removal of sand particles and other heavy debris that may settle to the bottom of the tank. The settled sand and other debris may be subsequently conveyed out of the tank and discarded.

As mentioned previously, the leachate removed from the lignocellulosic feedstock during or after leaching will comprise at least potassium. Depending on the leaching conditions, the leachate may also contain some calcium. Magnesium and sodium may be removed as well if the feedstock contains salts of these cations.

All or a portion of the leachate may be concentrated after it is removed from the lignocellulosic feedstock. That which is not concentrated may be disposed of as a bleed stream from the process. Typically, the leachate will have a concentration of between about 1 to 10 wt % total dissolved solids, or any amount therebetween, more typically about 3 to about 5 wt % (w/w). For example, the leachate may have a concentration of 1, 2, 3, 4, 5, 6, 7, 8, 9 or 10 wt % total dissolved solids. The leachate can be concentrated by any suitable technique known to those of ordinary skill in the art. Non-limiting examples of suitable concentration methods include evaporation or reverse osmosis.

The evaporation may be conducted using any suitable evaporation system known to those of skill in the art. In one embodiment of the invention, concentration of the leachate is carried out with a falling film evaporator.

The evaporation may be carried out in a single-stage evaporator or may be a multiple-effect system, i.e., a system in which more than one evaporator is employed. The evaporation is typically a continuous process.

Multiple-effect evaporator systems provide for optimal steam economy, but have the drawback of increased capital expenditure relative to single effect evaporators. A single effect evaporator uses more steam than a multiple-effect system during operation, but requires less capital investment. A person of skill in the art can readily choose a suitable evaporation system by taking into account the foregoing cost considerations.

A multiple-effect evaporator system utilized in accordance with the invention can be forward fed, meaning that the feeding takes place so that the solution to be concentrated enters the system through the first effect, which is at the highest temperature, and is then fed from effect to effect with decreasing temperature. Alternatively, backward feeding may be utilized, in which the partially concentrated solution is fed from effect to effect with increasing temperature.

Falling film evaporation will typically concentrate the leachate to 55-65% (w/w) dissolved solids. To achieve higher concentrations than this, other types of evaporation units can be employed. This includes, but is not limited to, forced re-circulation evaporators and mechanical vapour recompression units. Further concentration can be employed to increase the undissolved solids concentration to 75% (w/w) or higher.

A person of skill in the art can readily select a suitable operating temperature for the evaporation. In one embodiment of the invention, the operating temperature is between about 100° C. and about 120° C., or or any amount therebetween, to aid decomposition of potassium bicarbonate to potassium carbonate, carbon dioxide and water.

The pressure employed during evaporation will typically vary between 1.4×10⁵ and 2.0×10⁵ pascal, or any amount therebetween. Higher pressure could potentially be employed, but will require registered pressure vessels, which increases cost. The vacuum applied to the system can be as low as 0.4×10⁵ pascal.

A reverse osmosis unit can be utilized prior to evaporation to pre-concentrate the leachate, depending on the osmotic pressure of the solution.

A further example of a technique for concentrating the leachate includes membrane filtration. Membrane filtration is a process of filtering a solution with a membrane so as to concentrate it. This includes microfiltration, which employs membranes of a pore size of 0.05-1 microns for the removal of particulate matter; ultrafiltration, which employs membranes with a cut-off of 500-50,000 mw for removing large soluble molecules; and reverse osmosis using nanofiltration membranes to separate small molecules from water. Membrane filtration may be used for clarification as well as concentration. Clarification is generally carried out prior to those filtration techniques utilizing smaller pore sizes, such as reverse osmosis to prevent fouling of the membrane. Two or more membrane filtrations could be utilized as required.

In one example of the invention, the leachate is concentrated by reverse osmosis. As would be appreciated by those of skill in the art, reverse osmosis involves the separation of solutions having different solute concentrations with a semi-permeable membrane by applying sufficient pressure to a liquid having a higher solute concentration to reverse the direction of osmosis across the membrane.

The final solids concentration of the concentrated leachate may be between about 20 wt % and about 80 wt % measured as total solids, or any amount therebetween, more typically between about 50 wt % and about 75 wt %. In embodiments of the invention, the final solids content is any range therebetween, for example having numerical limits of about 20, 25, 30, 35, 40, 45, 50, 55, 60, 65, 70, 75 or 80 wt %.

The pH of the concentrated leachate will be between about 7.0 to about 12.0, or or any amount therebetween. In embodiments of the invention, the pH of the concentrated leachate is between about 9.0 and about 12.0. This includes any sub-range therebetween, including ranges having numerical limits of 7.0, 7.5, 8.0, 8.5, 9.0, 9.5, 10.0, 10.5, 11.0, 11.5 or 12.0.

It should be appreciated that other alkali, such as sodium hydroxide, potassium hydroxide, ammonia or ammonium hydroxide, may also be added to the concentrated leachate to increase its pH prior to its recirculation to the alkaline conditioning stage. The alkali can be mixed with the concentrated leachate and then recirculated, or the two bases can be added separately. Mixing of the alkali prior to their addition is advantageous as it necessitates only one alkali addition point. However, before mixing, caution should be taken to ensure that the two solutions are chemically compatible.

If the concentrated leachate is supplemented with ammonia, it may be added directly to the slurry as ammonia gas. Alternatively, the gas may be pre-dissolved in water to form an ammonium hydroxide solution, which can then be added to the concentrated leachate.

### Alkaline Treatment

The alkali treatment, also referred to herein as “alkaline conditioning”, is employed to dissolve about 50% to about 100%, or any amount therebetween more typically about 75% to about 100% of the acetyl groups from the lignocellulosic feedstock, while converting less than about 10% of the xylan to xylose, more preferably less than 5%. Advantageously, this can be achieved by the specific combination of treatment conditions set forth below. As would be appreciated by those of ordinary skill in the art, removal of all the acetyl groups may not be achievable in practice, or at least may not be economically feasible.

The degree of deacetylation is measured as set forth in Example 2.

As used herein, the “acetyl” or “acetyl group” present on xylan refers to a side chain substituent with the chemical formula C(O)CH₃, linked to a beta-1,4 linked xylan backbone polymer of the hemicellulose. As would be appreciated by those of skill in the art, the position and frequency of substitution of the acetyl group side chains attached to xylan varies among feedstocks.

Alkali is added to the lignocellulosic feedstock in order to increase the pH of the feedstock to between about 8.0 and about 12.0 or any range therebetween, including a pH range of 9.0 to 12.0. This also includes ranges having numerical limits of 8.0, 8.5, 9.0, 9.5, 10.0, 10.5, 11.0, 11.5, 12.0 or 12.5. It should be understood that the pH may vary through the alkali treatment step. In practice, the pH will tend to drop as the reaction takes place. The pH can be controlled at a constant value by the intermittent addition of alkali, or it can be allowed to vary within a desired range.

The concentration of the alkali solution added to the lignocellulosic feedstock may be between about 0.1 and about 2.0 millimoles of alkali per gram of dry feedstock, or any amount therebetween. This includes all values therebetween, including 0.1, 0.2, 0.3, 0.4, 0.5, 0.6, 0.7, 0.8, 0.9, 1.0, 1.1, 1.2, 1.3, 1.4 and 1.5 millimoles alkali per gram feedstock.

Without being limiting, alkali that can be utilized for removing the acetyl groups include sodium hydroxide, ammonia, ammonium hydroxide, potassium hydroxide, calcium hydroxide or calcium carbonate. Preferred alkali is sodium hydroxide or potassium hydroxide.

Optionally, alkali that is added to the feedstock may be concentrated leachate obtained by leaching the feedstock as described previously. The concentrated leachate may be used as the sole means for increasing the pH or it may be supplemented with other alkali, such as those listed above.

The temperature of the alkali treatment may be between about 20° C. and about 120° C., or any amount therebetween, between about 60° C. and about 120° C., or between about 70° and about 120° C. This includes all values therebetween, including ranges having numerical limits of 20, 25, 30, 34, 40, 45, 50, 55, 60, 65, 70, 75, 80, 85, 90, 95, 100, 105, 110, 115 or 120° C. If a temperature of greater than 100° C. is utilized, the alkali treatment will be conducted in a pressurized vessel. Thus, according to one embodiment of the invention, the temperature range of the alkali treatment is between about 70° C. and about 100° C.

The fiber solids concentration during the alkali treatment step may be between about 1% and 15% (w/v), or any amount therebetween, or between about 3% and about 8% (w/v).

The reaction volume for the alkaline conditioning may be between about 1000 to about 100,000 liters, for example between about 5,000 and about 25,000 liters. The reaction may be carried out as a batch, continuous or fed-batch process. The alkaline treatment may be conducted with mixing, mechanical agitation, recirculation pumping or a combination thereof. Alternatively, the treatment can be carried out without mixing.

The residence time during the alkali treatment may be between about 5 minutes and about 180 minutes, or any amount therebetween. According to one embodiment of the invention, the residence time is between about 5 minutes and about 120 minutes or between about 30 minutes and about 100 minutes.

Limited or no dissolution or degradation of xylan and cellulose occurs during the alkaline conditioning. For example, less than 10%, 5% or 2% dissolution or degradation of the xylan and cellulose preferably occurs during the alkaline treatment step.

As well, some dissolution of the lignin in the feedstock may occur; for example from 0% to 25% of the lignin, or any amount therebetween, may be dissolved during the alkali treatment. According to one embodiment of the invention from 0% to 15% of the lignin is dissolved during the alkali treatment.

Subsequent to the alkali treatment to remove the acetyl groups from the xylan, the feedstock residue that remains is optionally separated from the feedstock. Such a separation step removes the acetate that was liberated from the feedstock during the alkali treatment, along with any lignin that was also dissolved. The foregoing separation may be carried out by washing the pretreated feedstock composition with an aqueous solution to produce a wash stream, and a solids stream comprising the unhydrolyzed, pretreated feedstock. Alternatively, soluble components are separated from the solids by subjecting the pretreated feedstock composition to a solids-liquid separation, using known methods such as centrifugation, microfiltration, plate and frame filtration, cross-flow filtration, pressure filtration, vacuum filtration and the like. Optionally, a washing step may be incorporated into the solids-liquids separation.

### Dilute Acid Pretreatment

After alkali treatment to remove the acetyl groups on the lignocellulosic feedstock, a dilute acid pretreatment is employed to increase the susceptibility of the lignocellulosic feedstock to hydrolysis by cellulase enzymes. The dilute acid pretreatment is carried out to hydrolyze the hemicellulose that is present in the lignocellulosic feedstock to monomeric sugars, for example xylose, arabinose, mannose, galactose, or a combination thereof. The dilute acid pretreatment is conducted under conditions so that complete or significant hydrolysis of the xylan and so that some limited conversion of cellulose to glucose occurs. That is, the dilute acid pretreatment is conducted so that between about 80% and up to 100% of the xylan is hydrolyzed, while 3-15% of the cellulose is hydrolyzed. The majority of the cellulose is hydrolyzed to glucose in a subsequent step that uses cellulase enzymes.

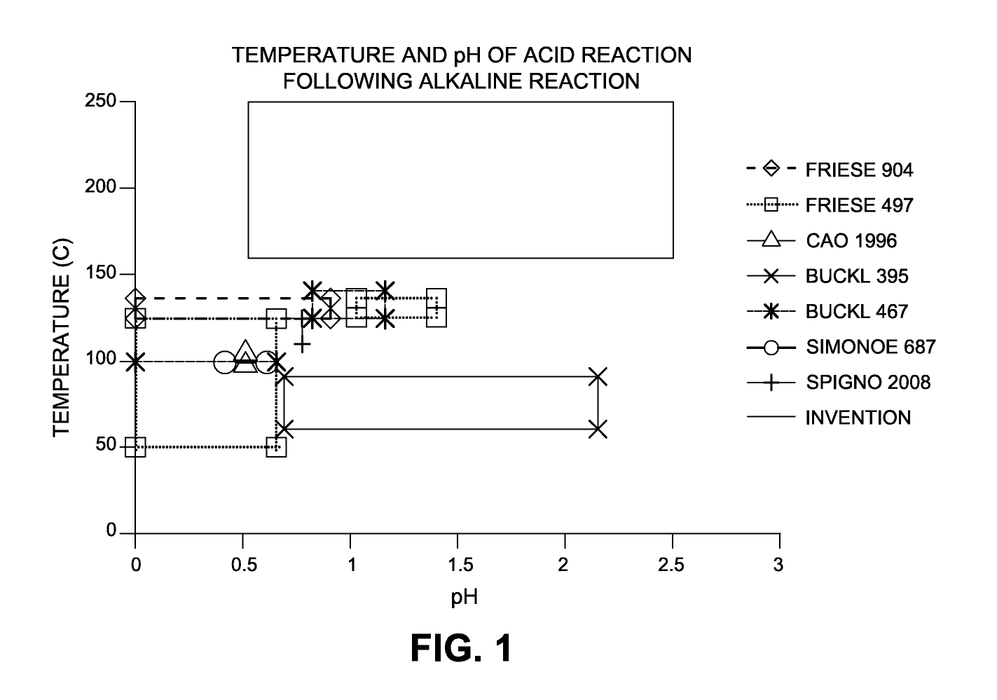

The dilute acid pretreatment is conducted at a temperature range of 160° C. to 250° C., or any temperature therebetween, and a pH between 0.5 and 2.5, or any pH therebetween. This pH and temperature range is shown in FIG. 1, indicated as “invention”. This range produces a high xylose yield and prepares the feedstock for an efficient enzymatic hydrolysis of cellulose to glucose. A suitable temperature, pH and residence time can be selected within the foregoing ranges to achieve about 80% up to 100% conversion of the xylan, while maintaining the degree of cellulose hydrolysis at 3-15%. In one embodiment of the invention, the pretreatment pH is 1.5 to 2.5 and the temperature is 180° C. to 220° C.

The amount of acid added may vary, but the resulting pH of the feedstock is about pH 0.5 to about pH 2.5, or any pH range therebetween. For example, the pH of the slurry may be between about 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4 or 2.5 or any amount therebetween. The pretreatment pH utilized in the process will depend on the retention time, temperature and the feedstock used. A suitable pH can be selected within this pH range to hydrolyze at least about 80% of the xylan, while maintaining the degree of cellulose hydrolysis at 3-15%.

The temperature of the acid pretreatment is between about 160° C. and about 250° C., or any temperature therebetween. For example, the temperature may be about 160, 165, 170, 175, 180, 185, 190, 195, 200, 205, 210, 215, 220, 225, 230, 235, 240, 245 or 250° C. The pretreatment temperature utilized in the process will depend on the retention time, acid concentration and the feedstock used. A suitable temperature can be selected within this range to hydrolyze at least about 80% of the xylan, while maintaining the degree of cellulose hydrolysis at 3-15%.

The concentration of the slurry entering the acid pretreatment system may be about 4% to 35% (w/w) feedstock solids, or any amount therebetween. Without being limiting, a feedstock slurry may be dewatered to between about 16% to about 35% (w/w) prior to acid pretreatment, for example by pressing the feedstock slurry under pressure as set forth in co-pending and co-owned WO 2010/022511.

Preferably, the dilute acid pretreatment is carried out to minimize the degradation of xylose and the production of furfural. For example, less than about 15% of the xylan in the feedstock may be converted to furfural in pretreatment and the amount of hydroxymethylfurfural produced in pretreatment is less than about 5 wt % of the amount of glucose produced in the pretreatment and enzyme hydrolysis step.

Examples of acids that can be used in the process include those selected from the group consisting of sulfuric acid, sulfurous acid, sulfur dioxide and a combination thereof. The preferred acid is sulfuric acid. The acid may be stored as a 93% w/w concentrate. Hydrochloric acid is not a preferred acid due to its corrosive effect on process equipment.

As would be appreciated by those of skill in the art, measurement of pH presents a challenge at the elevated temperature and pressure of a pretreatment system and pH probes at these conditions are not reliable. For the purpose of this specification, the pH of pretreatment is the pH value measured by adding acid and water (and other liquids if present) to the feedstock at a temperature of 25° C. at the concentrations present at the entrance to the pretreatment reactor.

The feedstock may be heated with steam during pretreatment. In a non-limiting example, one method to carry this out is to use low pressure steam to partially heat the feedstock, which is then pumped to a heating train of several stages and exposed to steam of increasing pressure at each stage.

The retention time in the pretreatment reactor will vary depending on the temperature, acid concentration, feedstock used, and the degree of treatment desired. For example, the slurry could be retained in the pretreatment reactor for about ½ to about 20 minutes, or any time therebetween. That is, the retention time may be about 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5 or 20 minutes.

The pretreatment is carried out under pressure. The pressure of the system is that corresponding to saturated steam at the pretreatment temperature. For example, saturated steam at 200° C. is at 226 psia. The pressure of the system can range between 90 psia (160° C.) and 575 psia (250° C.). For example, the pressure range can include numerical limits of 90, 150, 200, 250, 300, 350, 400, 450, 500, 550 or 575.

In a particularly advantageous embodiment of the invention, the pretreatment temperature, pH, and time are chosen as follows. The alkaline conditioning increases the rate of hydrolysis of the xylan during dilute acid pretreatment. This allows choices of pretreatment time, temperature, and pH to be made at milder conditions than can be achieved in the absence of alkaline conditioning.

As would be appreciated by those of skill in the art, the pretreatment time and temperature are linked: the higher the temperature, the shorter the time. It is therefore convenient to calculate a kinetic time that accounts for the time scales across a range of temperatures. This is accomplished over temperatures between 160° C. and 250° C. by using Equation (1):

t*=t×2^{(T-200)/13.9} (1)

where
t*=kinetic time (seconds)
t=actual time (seconds)
T=temperature, ° C.

Equation (1) uses a baseline of pretreatment at 200° C. At temperatures lower than 200° C., the kinetic time is shorter than the actual time. At temperatures longer than 200° C., the kinetic time is longer than the actual time. Those skilled in the art would be aware that Equation (1) is for a constant temperature, and that if the temperature varies with time, t* is determined by integration of Equation (1) over time.

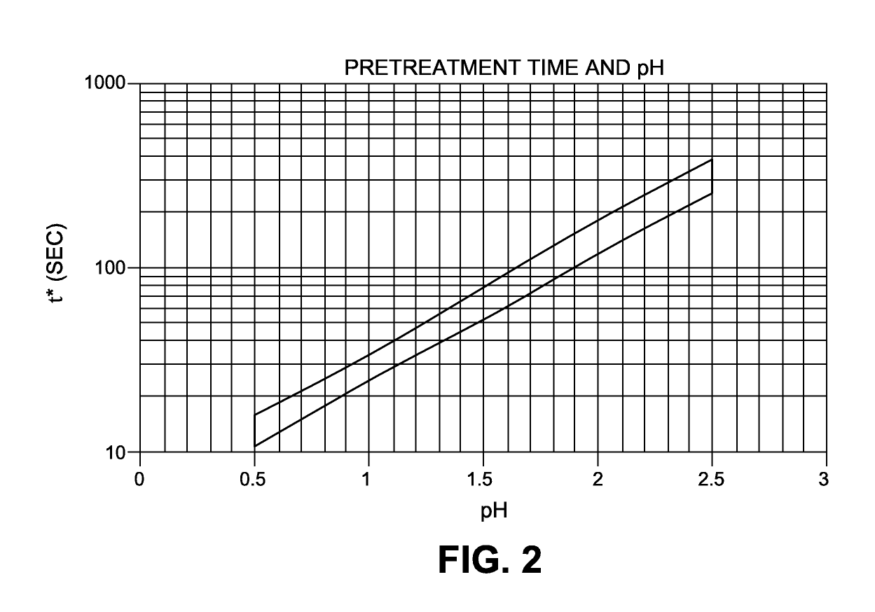

FIG. 2 shows the ranges of t* and pH that can be employed following alkaline conditioning. The pretreatment conditions following alkaline conditioning are milder than conventional pretreatment. This is discussed in more detail in Example 6.

In those embodiments in which the pretreatment parameters fall within the ranges set out in FIG. 2, it should be noted that the pH is that measured at 25° C. and is the time-average value during the pretreatment process.

The pretreatment reactor may be a cylindrical pipe to convey a plug flow of feedstock slurry therethrough. Alternatively, the pretreatment reactor is a horizontally-oriented vessel having a cylindrical screw conveyor for moving the feedstock through the reactor in an axial direction as set forth in co-owned and co-pending WO 2010/022511 (Anand et al.).

The pretreatment results in a pretreated feedstock composition (e.g., pretreated feedstock slurry) that contains a soluble component including the sugars resulting from hydrolysis of the xylan and solids that contain unhydrolyzed feedstock including cellulose and lignin.

The pretreatment is typically a continuous process, meaning that the lignocellulosic feedstock is conveyed through the pretreatment reactor continuously. However, pretreatment can be carried out as a batch process (U.S. Pat. No. 4,461,648).

According to one embodiment of the invention, the soluble components of the pretreated feedstock composition are separated from the solids. The soluble fraction, which includes the sugars released during pretreatment and other soluble components, including inhibitors, may then be sent to a fermentation that converts these sugars to fermentation products.

The foregoing separation may be carried out by washing the pretreated feedstock composition with an aqueous solution to produce a wash stream, and a solids stream comprising the unhydrolyzed, pretreated feedstock. Alternatively, soluble components are separated from the solids by subjecting the pretreated feedstock composition to a solids-liquid separation, using known methods such as centrifugation, microfiltration, plate and frame filtration, cross-flow filtration, pressure filtration, vacuum filtration and the like. Optionally, a washing step may be incorporated into the solids-liquids separation. The separated solids, which contain cellulose, may then be sent to enzymatic hydrolysis with cellulase enzymes in order to convert the cellulose to glucose. The resultant glucose-containing stream may then be fermented to ethanol, butanol or other fermentation products.

Subsequent to pretreatment, the pretreated feedstock slurry is typically cooled prior to enzymatic hydrolysis to decrease it to a temperature at which the cellulase enzymes are active. It should be appreciated that cooling of the feedstock can occur in a number of stages utilizing flashing, heat exchange, dilution with water or other suitable means. In one embodiment of the invention, the pretreated feedstock is cooled to temperatures of about 100° C. and below before enzymatic hydrolysis.

Enzymatic Hydrolysis with Cellulase

The enzymatic hydrolysis of the cellulose in the acid pretreated feedstock to soluble sugars can be carried out with any type of cellulase enzymes suitable for such purpose and effective at the pH and other conditions utilized, regardless of their source. Among the most widely studied, characterized and commercially produced cellulases are those obtained from fungi of the genera Aspergillus, Humicola, Chrysosporium, Melanocarpus, Myceliopthora, Sporotrichum and Trichoderma, and from the bacteria of the genera Bacillus and Thermobifida. Cellulase produced by the filamentous fungi Trichoderma longibrachiatum comprises at least two cellobiohydrolase enzymes termed CBHI and CBHII and at least four EG enzymes. As well, EGI, EGII, EGIII, EG V and EGVI cellulases have been isolated from Humicola insolens (see Lynd et al., 2002, Microbiology and Molecular Biology Reviews, 66(3):506-577 for a review of cellulase enzyme systems and Coutinho and Henrissat, 1999, “Carbohydrate-active enzymes: an integrated database approach.” In Recent Advances in Carbohydrate Bioengineering, Gilbert, Davies, Henrissat and Svensson eds., The Royal Society of Chemistry, Cambridge, pp. 3-12, each of which are incorporated herein by reference).

In addition to CBH, EG and beta-glucosidase, there are several accessory enzymes that aid in the enzymatic digestion of cellulose (see co-owned WO 2009/026722 (Scott), which is incorporated herein by reference, and Harris et al., 2010, Biochemistry, 49:3305-3316). These include EGIV, also known as Cel61, swollenin, expansin, lucinen and cellulose-induced protein (Cip). Glucose can be enzymatically converted to the dimers gentiobiose, sophorose, laminaribiose and others by beta-glucosidase via transglycosylation reactions.

An appropriate cellulase dosage can be about 1.0 to about 40.0 Filter Paper Units (FPU or IU) per gram of cellulose, or any amount therebetween. The FPU is a standard measurement familiar to those skilled in the art and is defined and measured according to Ghose (Pure and Appl. Chem., 1987, 59:257-268; which is incorporated herein by reference). A preferred cellulase dosage is about 10 to 20 FPU per gram cellulose.

The conversion of cellobiose to glucose is carried out by the enzyme β-glucosidase. By the term “β-glucosidase”, it is meant any enzyme that hydrolyzes the glucose dimer, cellobiose, to glucose. The activity of the β-glucosidase enzyme is defined by its activity by the Enzyme Commission as EC#3.2.1.21. The β-glucosidase enzyme may come from various sources; however, in all cases, the β-glucosidase enzyme can hydrolyze cellobiose to glucose. The β-glucosidase enzyme may be a Family 1 or Family 3 glycoside hydrolase, although other family members may be used in the practice of this invention. The preferred β-glucosidase enzyme for use in this invention is the Bgl1 protein from Trichoderma reesei. It is also contemplated that the β-glucosidase enzyme may be modified to include a cellulose binding domain, thereby allowing this enzyme to bind to cellulose.

The enzymatic hydrolysis is generally conducted at a pH between about 4.0 and 6.0 as this is within the optimal pH range of most cellulases. As the pH of the pretreated lignocellulosic feedstock is acidic, its pH will be increased with alkali to about pH 4.0 to about 6.0 prior to enzymatic hydrolysis, or more typically between about 4.5 and about 5.5. However, cellulases with pH optima at more acidic and more alkaline pH values are known.

The alkali for pH adjustment of the pretreated feedstock can be added to the pretreated feedstock after it is cooled, before cooling, or at points both before and after cooling. The alkali may be added in-line to the pretreated feedstock, such as an in-line dispersion device described previously, to a pump downstream of pretreatment or directly to a hydrolysis vessel. The point of alkali addition can coincide with the cellulase enzyme addition, or it can be added upstream or downstream of the location of the enzyme addition.

The temperature of the slurry is adjusted so that it is within the optimum range for the activity of the cellulase enzymes. Generally, a temperature of about 45° C. to about 70° C., or about 45° C. to about 65° C., or any temperature therebetween, is suitable for most cellulase enzymes. However, the temperature of the slurry may be higher for thermophilic cellulase enzymes.

In order to maintain the desired hydrolysis temperature, the hydrolysis reactors may be jacketed with steam, hot water, or other heat sources. Moreover the reactors may be insulated to retain heat.

It is generally preferred that enzymatic hydrolysis and fermentation are conducted in separate vessels so that each biological reaction can occur at its respective optimal temperature. However, the hydrolysis may be conducted simultaneously with fermentation in a simultaneous saccharification and fermentation. SSF is typically carried out at temperatures of 35-38° C., which is a compromise between the 50° C. optimum for cellulase and the 28° C. optimum for yeast. Consequently, this intermediate temperature can lead to substandard performance by both the cellulase enzymes and the yeast.

Other design parameters of the hydrolysis system may be adjusted as required. For example, the volume of a hydrolysis reactor in a cellulase hydrolysis system can range from about 100,000 L to about 20,000,000 L, or any volume therebetween, for example, between 200,000 and 5,000,000 L, or any amount therebetween. The total residence time of the slurry in a hydrolysis system may be between about 12 hours to about 200 hours, or any amount therebetween. The hydrolysis may be a batch, fed-batch or continuous process. The hydrolysis can be mixed or unmixed.

After the hydrolysis is complete, the product is glucose, cellobiose, gentiobiose and any unreacted cellulose. Insoluble solids present in the resulting stream, including lignin, may be removed using conventional solid-liquid separation techniques prior to any further processing. However, it may be desirable in some circumstances to carry forward both the solids and liquids in the sugar stream for further processing.

### Fermentation

Fermentation of glucose resulting from the hydrolysis may produce one or more of the fermentation products selected from an alcohol, a sugar alcohol, an organic acid and a combination thereof.

The fermentation is typically conducted at a pH between about 4.0 and about 6.0, or between about 4.5 and about 6.0. To attain the foregoing pH range for fermentation, it may be necessary to add alkali to the stream comprising glucose.

In one embodiment of the invention, the fermentation product is an alcohol, such as ethanol or butanol. For ethanol production, the fermentation is typically carried out with a Saccharomyces spp. yeast. Glucose and any other hexoses present in the sugar stream may be fermented to ethanol by wild-type Saccharomyces cerevisiae, although genetically modified yeasts may be employed as well, as discussed below. The ethanol may then be distilled to obtain a concentrated ethanol solution. Butanol may be produced from glucose by a microorganism such as Clostridium acetobutylicum and then concentrated by distillation.

Xylose and arabinose that are derived from the xylan may also be fermented to ethanol by a yeast strain that naturally contains, or has been engineered to contain, the ability to ferment these sugars to ethanol. Examples of microbes that have been genetically modified to ferment xylose include recombinant Saccharomyces strains into which has been inserted either (a) the xylose reductase (XR) and xylitol dehydrogenase (XDH) genes from Pichia stipitis (U.S. Pat. Nos. 5,789,210, 5,866,382, 6,582,944 and 7,527,927 and European Patent No. 450530) or (b) fungal or bacterial xylose isomerase (XI) gene (U.S. Pat. Nos. 6,475,768 and 7,622,284). Examples of yeasts that have been genetically modified to ferment L-arabinose include, but are not limited to, recombinant Saccharomyces strains into which genes from either fungal (U.S. Pat. No. 7,527,951) or bacterial (WO 2008/041840) arabinose metabolic pathways have been inserted.

Organic acids that may be produced during the fermentation include lactic acid, citric acid, ascorbic acid, malic acid, succinic acid, pyruvic acid, hydroxypropanoic acid, itaconic acid and acetic acid. In a non-limiting example, lactic acid is the fermentation product of interest. The most well-known industrial microorganisms for lactic acid production from glucose are species of the genera Lactobacillus, Bacillus and Rhizopus.

Moreover, xylose and other pentose sugars may be fermented to xylitol by yeast strains selected from the group consisting of Candida, Pichia, Pachysolen, Hansenula, Debaryomyces, Kluyveromyces and Saccharomyces. Bacteria are also known to produce xylitol, including Corynebacterium sp., Enterobacter liquefaciens and Mycobacterium smegmatis.

In practice, the fermentation is performed at or near the temperature and pH optimum of the fermentation microorganism. A typical temperature range for the fermentation of glucose to ethanol using Saccharomyces cerevisiae is between about 25° C. and about 35° C., although the temperature may be higher if the yeast is naturally or genetically modified to be thermostable. The dose of the fermentation microorganism will depend on other factors, such as the activity of the fermentation microorganism, the desired fermentation time, the volume of the reactor and other parameters. It should be appreciated that these parameters may be adjusted as desired by one of skill in the art to achieve optimal fermentation conditions.

The fermentation may also be supplemented with additional nutrients required for the growth of the fermentation microorganism. For example, yeast extract, specific amino acids, phosphate, nitrogen sources, salts, trace elements and vitamins may be added to the hydrolyzate slurry to support their growth.

The fermentation may be conducted in batch, continuous or fed-batch modes with or without agitation. Preferably, the fermentation reactors are agitated lightly with mechanical agitation. A typical, commercial-scale fermentation may be conducted using multiple reactors. The fermentation microorganisms may be recycled back to the fermentor or may be sent to distillation without recycle.

If ethanol or butanol is the fermentation product, the recovery is carried out by distillation, typically with further concentration by molecular sieves or membrane extraction.

The fermentation broth that is sent to distillation is a dilute alcohol solution containing solids, including unconverted cellulose, and any components added during the fermentation to support growth of the microorganisms.

Microorganisms are potentially present during the distillation depending upon whether or not they are recycled during the fermentation. The broth is preferably degassed to remove carbon dioxide and then pumped through one or more distillation columns to separate the alcohol from the other components in the broth. The mode of operation of the distillation system depends on whether the alcohol has a lower or a higher boiling point than water. Most often, the alcohol has a lower boiling point than water, as is the case when ethanol is distilled.

For ethanol concentration, the column(s) in the distillation unit is preferably operated in a continuous mode, although it should be understood that batch processes are also encompassed by the present invention. Heat for the distillation process may be introduced at one or more points either by direct steam injection or indirectly via heat exchangers. The distillation unit may contain one or more separate beer and rectifying columns, in which case dilute beer is sent to the beer column where it is partially concentrated. From the beer column, the vapour goes to a rectification column for further purification. Alternatively, a distillation column is employed that comprises an integral enriching or rectification section.

After distillation, the water remaining may be removed from the vapour by a molecular sieve resin, by membrane extraction, or other methods known to those of skill in the art for concentration of ethanol beyond the 95% that is typically achieved by distillation. The vapour may then be condensed and denatured.

An aqueous stream(s) remaining after ethanol distillation and containing solids, referred to herein as “still bottoms”, is withdrawn from the bottom of one or more of the column(s) of the distillation unit. This stream will contain inorganic salts, unfermented sugars and organic salts.

When the alcohol has a higher boiling point than water, such as butanol, the distillation is run to remove the water and other volatile compounds from the alcohol. The water vapor exits the top of the distillation column and is known as the “overhead stream”.

### EXAMPLES

### Example 1

### Comparative Example

The dilute acid pretreatment of the alkali conditioned feedstock is conducted at a temperature range of 160° C. to 250° C., and a pH between 0.5 and 2.5. This pH and temperature range is shown in FIG. 1, indicated as “present invention”. This range produces a high xylose yield and prepares the feedstock for an efficient enzymatic hydrolysis of cellulose to glucose. A suitable temperature, pH and residence time can be selected within the foregoing ranges to achieve about 80% up to 100% conversion of the xylan, while maintaining the degree of cellulose hydrolysis at 3-15%.

Although the use of alkaline reactions followed by acid reactions has been reported in the prior art, the pH and temperature ranges in these reports are not adequate for pretreatment of the feedstock. The reported ranges of pH and temperature for the acid reactions are shown in FIG. 1. The prior art conditions accomplish the production of some xylose from xylan, but do not achieve 3-15% cellulose hydrolysis.

In addition, the pretreatment time for practicing the present invention is significantly shorter than the times reported for acidic reactions following alkaline reactions. Table 1 lists the times reported for acidic reactions.

TABLE 1
Acidic reaction times

| | Acidic reaction |
|---|---|
| Report | time (minutes) |
| Present invention | 0.5-10 |
| Friese, U.S. Pat. No. 3,990,904 | 60-120 |
| Friese, U.S. Pat. No. 3,954,497 | 60-240 |
| Fahn, U.S. Pat. No. 4,072,538 | 15-45 |
| Buckl, U.S. Pat. No. 4,105,467 | 60-120 |
| Simonoe, U.S. Pat. No. | 90-100 |
| 3,565,687 | |
| Cao et al, Biotechnology Letters, | 60 |
| 1996, 18(9): 1013-1018 | |

### Example 2

### Lab-Scale Alkaline Conditioning to Determine the Alkali Dosage for Deacetylation

Wheat straw containing 17.0% moisture and 2.75% acetyl groups (as acetic acid) was chopped to ½ inch length. The acetyl groups were removed by alkaline conditioning, as follows.

Stirred alkaline conditioning reactions were carried out at an initial dosage of potassium hydroxide (KOH) of 50 mg per gram of straw (50 mg/g) at 85° C. in beakers containing 10 g straw in 250 mL water. The KOH was added as a 30% (w/w) solution in water. The beakers with straw and water were placed in a 120° C. mineral oil bath. When the temperature reached 85° C., the KOH was added. The pH was monitored with a probe equipped with temperature compensation to 25° C. The pH drifted downwards with time as the acetyl groups were released from the straw. The final pH stabilized within 0.5-1 hours.

A preliminary experiment was conducted to determine the approximate amount of alkali needed to maintain pH 11.0+/−0.1 and the corresponding degree of deacetylation of the straw. The degree of deacetylation is determined by filtering off insoluble solids, measuring the acetic acid concentration dissolved in the aqueous phase by HPLC and subsequently comparing this with the initial concentration of acetyl groups in the straw. The concentration of acetyl groups in the straw is measured by subjecting fine ground straw to hydrolysis with 72% sulfuric acid for 30 minutes at 30° C., then diluting to 1% sulfuric acid by adding water and incubating at 121° C. for 1 hour, then filtering and measuring the acetic acid by HPLC. This procedure is NREL Laboratory Analytical Procedure (LAP), Determination of Structural Carbohydrates and Lignin in Biomass, NREL Technical Report, NREL/TP-510-42618, Revised April, 2008. The results are shown in Table 2 and indicate that 88.23% deacetylation is achieved with 77.3 mg KOH/g straw.

TABLE 2
Change in pH with time and deacetylation data

| | | Alkali | | |
|---|---|---|---|---|
| | | dosage | | |
| | | (mg | | |
| Time | pH | KOH/g | pH | |
| (min) | before | straw) | after | Deacetylation (%) |
| 0 | 7.30 | | | 0 |
| 2 | 7.30 | 50.1 | 11.50 | |
| 3 | 10.90 | 1.7 | 11.10 | |
| 4 | 11.00 | 6.0 | 11.00 | |
| 5 | 10.80 | 6.0 | 11.05 | |
| 6 | 10.93 | 6.0 | 11.11 | |
| 7 | 11.00 | 6.0 | 11.06 | |
| 9 | 10.92 | 1.5 | 10.90 | 69.25 |
| Final | | 77.3 | | 88.23 |

In a second set of experiments at 85° C., KOH was added at 0, 20 and 40 min (see Tables 3 and 4) and the pH recorded before and after alkali addition. Samples of the slurry were taken at 20, 40, 60 and 90 min time points immediately before base addition, filtered, and washed with water. The filtrates were analyzed for acetate content and the solids were air-dried for carbohydrate analysis. A small amount of hot water was added as the experiment progressed to maintain a constant water level in the beaker, as some evaporation was taking place.

The degree of deacetylation was over 98% with 80 mg/g of KOH. With 60 mg/g of KOH, over 93% deacetylation was achieved.

TABLE 3
Data from 50 + 15 + 15 (mg KOH/g straw)

| | | pH | pH | |
|---|---|---|---|---|
| Time | Initial | before | after | Deacetylation |
| (min) | pH | KOH | KOH | (%) |
| 0 | 11.6 | | | |
| 18 | | 9.69 | | 61.28 |
| 20 | | | 10.26 | |
| 38 | | 9.89 | | 56.05 |
| 40 | | | 10.43 | |
| 60 | | 10.12 | | 69.87 |
| 90 | | 9.97 | | 98.57 |

TABLE 4
Data from 40 + 10 + 10 (mg KOH/g straw)

| | | pH | pH | |
|---|---|---|---|---|
| Time | Initial | before | after | Deacetylation |
| (min) | pH | KOH | KOH | (%) |
| 0 | 11.34 | | | |
| 18 | | 9.78 | | 55.83 |
| 20 | | | 10.43 | |
| 38 | | 9.92 | | 56.04 |
| 40 | | | 10.48 | |
| 60 | | 10.02 | | 76.14 |
| 90 | | 9.97 | | 93.91 |

### Example 3

### Xylan Solubilization of Alkali Conditioned Feedstock

Wheat straw at 17% moisture was milled to an average size of 1 inch and subjected to alkaline conditioning. This was carried out by combining the milled straw with pH 10.0 or pH 12.0 NaOH solution in a liquid to solid ratio of 25:1 in a round bottomed flask. The flask was fitted with a reflux condenser and the suspension was heated to reflux at 100° C. for 4 h. After the time elapsed, the flask was allowed to cool and the suspension was filtered using a large Buchner funnel to isolate the solids. The solids were washed with 6 equivalents of deionized water and 2 equivalents of 50 mM sodium citrate buffer to remove any residual caustic solution sequestered in the straw. After the washing step, the solid was collected and air dried.

The pretreatment of the alkaline conditioned material was carried out in ¾″×5″ lab bombs. Each bomb was loaded with about 0.25 g of dried, alkaline conditioned straw (or raw straw) and about 15 g of pH 1.55 sulfuric acid solution. This gave a liquid to solid ratio of 60:1 in each bomb. Ten bombs were run for 50, 75, 82, 93, 115, 150, 175 and 210 seconds to generate enough solids for residual xylan analysis. The bombs were cooked individually at an oil bath temperature of 230° C. at pH 1.55 for the abovementioned lengths of time, and then cooled in ice water for a few minutes. After cooling, the bombs were emptied and rinsed out with deionized water into a tared cup. The contents were then filtered using a vacuum manifold and Buchner funnels. The solids from each time point were analyzed by dissolution with 72% sulfuric acid to determine their residual xylan contents.

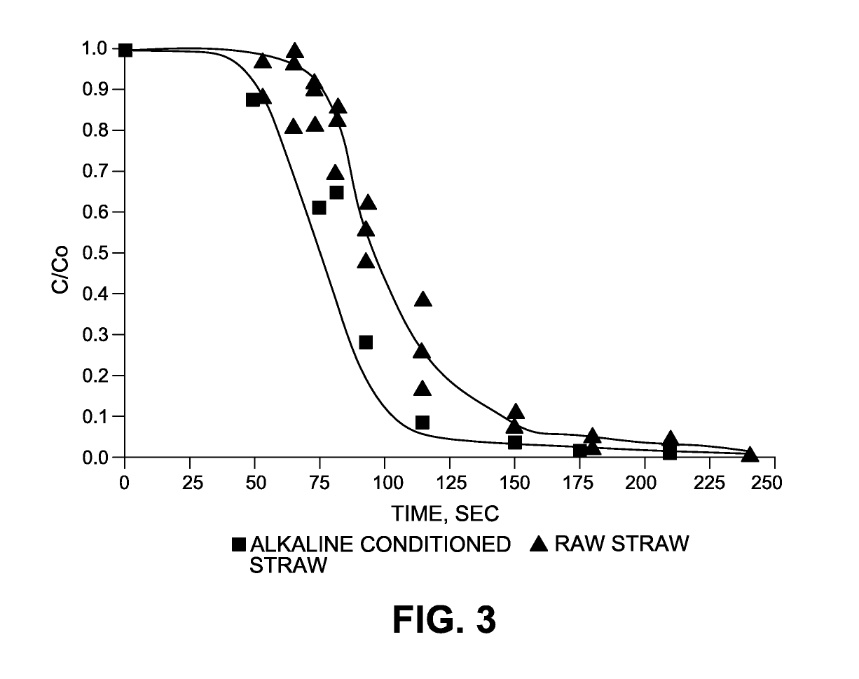

The resulting xylan solubilization is shown in Table 5. FIG. 3 shows the final xylan concentration (C) over the initial xylan concentration (Co) at each time point for alkaline conditioned and untreated, raw straw. The rate of xylan solubilization for the alkaline conditioned straw was faster than that of the raw straw (FIG. 3).

TABLE 5
Xylan content of pH 10 conditioned wheat straw

| | Xylan content |
|---|---|
| Time | (Percent of initial) |
| 50 s | 87.38 |
| 75 s | 60.41 |
| 82 s | 64.50 |
| 93 s | 27.40 |
| 115 s | 7.70 |
| 150 s | 2.02 |
| 175 s | 0.65 |
| 210 s | 0.55 |

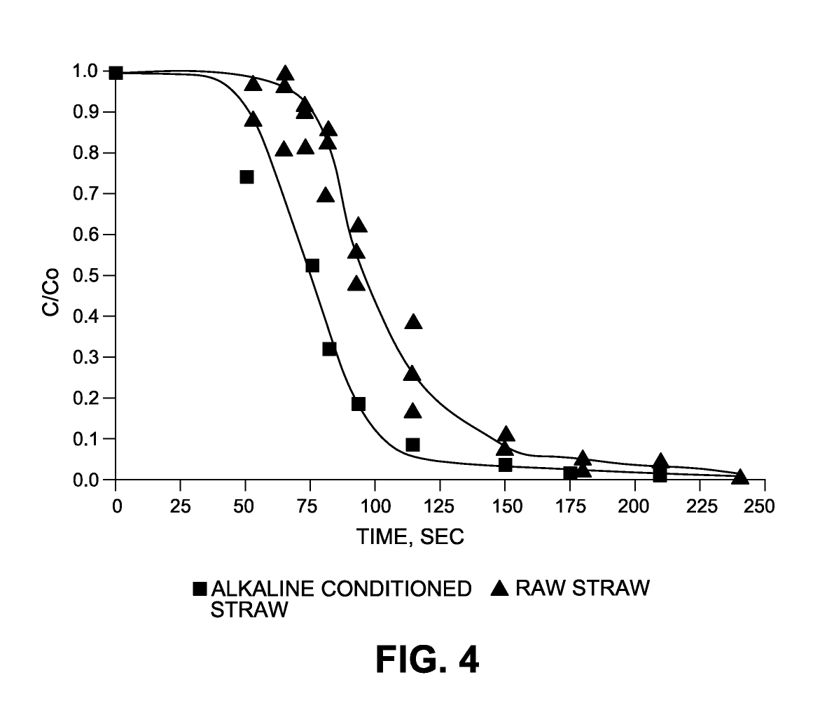

The pretreatment series was repeated for the pH 12 conditioned wheat straw (FIG. 4). The rate of xylan solubilization was significantly faster than the pH 10 conditioned straw at the earliest time points. However, by 115 s the rates of xylan dissolution for the two alkaline conditions were approximately the same.

### Example 4

### Large Scale Alkaline Conditioning of Wheat Straw

Wheat straw with 16.5% moisture and 2.51% acetyl groups was pulped to an average size of ½ inch length and slurried in water at a target solids consistency of 4%. The actual consistency was measured and used for subsequent calculations. The volume of the slurry in the slurry vessel was about 13,000 liters and the weight of straw was about 500 kg. The slurry was gently agitated during the alkaline conditioning reaction. The target temperature was 90° C. but the actual temperature was measured and recorded.

To ensure a high deacetylation of straw, and based on the data in Example 2, the initial KOH dosage chosen for the first large scale run was 60 mg KOH/g of straw. This was followed by the addition of 15 mg KOH/g of straw after 20 and 40 minutes and carrying out the conditioning for 1.5 total hours. After alkaline conditioning, the slurry was fed to a screw press and pressed without neutralization to increase its concentration. The pressed, conditioned straw was then carried through to pretreatment. The large scale alkaline conditioning generated roughly 90% deacetylated straw. Table 6 is a summary of the four alkaline conditioning runs.

TABLE 6
Results of large scale alkaline conditioning

| | Day 1 | Day 2 | Day 3 | Day 4 |
|---|---|---|---|---|
| Temperature (° C.) | 70-75 | 82-84 | 78-85 | 85 |
| Deacetylation (%) | 90.8 | 84.7 | 89.4 | 89.4 |
| t = 0 KOH dosage (mg/g) | 64.8 | 57.4 | 75.7 | 77.6 |
| t = 20 KOH dosage (mg/g) | 19.4 | 17.2 | 19.8 | 20.3 |
| t = 40 KOH dosage (mg/g) | 19.4 | 17.2 | 19.8 | 20.3 |
| Solids (%) | 3.1 | 3.48 | 3.44 | 3.35 |
| Acetate (g/L in pressate) | 0.81 | 0.89 | 0.78 | 1.03 |
| Acetate in conditioned solids | 0.265 | 0.45 | 0.315 | 0.31 |
| (%) | | | | |

There was no evidence of glucan or xylan degradation or dissolution in the large scale conditioning. The data shown in Tables 7 and 8 indicates that the conditioned straw contained an average of 420 mg of cellulose and 228.5 mg of xylan per g of straw. These values are higher than for raw straw because of the loss of non-carbohydrate solids during the process. To compare the carbohydrates in raw straw with conditioned straw, the solids dissolved during conditioning should be accounted for. Using an average dissolution of solids of 15% (based on the change in slurry consistency during conditioning) the cellulose and xylan content, within the precision of the assay (5-10%), is unchanged.

TABLE 7
Cellulose concentration before and after alkaline conditioning of
wheat straw

| | | Normalized cellulose |
|---|---|---|
| Sample | Cellulose (mg/g) | concentration |
| raw straw* | 333.06 | 100 |
| Day 1 | 423.93 | 108.19 |
| Day 2 | 409.93 | 104.62 |
| Day 3 | 436.12 | 111.30 |
| Day 4 | 430.90 | 109.97 |

*average of two samples

TABLE 8
Xylan concentration before and after alkaline conditioning of wheat straw

| | | Normalized xylan |
|---|---|---|
| Sample | Xylan (mg/g) | concentration |
| raw straw* | 182.19 | 100 |
| Day 1 | 232.23 | 108.34 |
| Day 2 | 224.61 | 104.79 |
| Day 3 | 238.73 | 111.38 |
| Day 4 | 225.13 | 105.03 |

*average of two samples

### Example 5

### Large Scale Pretreatment of Alkali-Conditioned Straw

The wheat straw subjected to alkaline conditioning as set out in Example 4 on Day 1 was pretreated with dilute sulfuric acid at 185° C. as described in Foody, U.S. Pat. No. 4,461,648. After pretreatment, the xylose concentration of a sample of the filtrate was measured and this was used to determine the xylose yield. The results are shown in Table 9, which indicates that the xylose yields were 555 to 601 mg per gram of initial cellulose.

TABLE 9
Xylose yields

| | Xylose yield (mg/g initial |
|---|---|
| Run | cellulose) |
| Day 1 | 601 |
| Day 2 | 566 |
| Day 3 | 563 |
| Day 4 | 555 |

### Example 6

### Pretreatment of Alkaline Conditioned Wheat Straw Versus Wheat Straw not Subjected to Pretreatment

The wheat straw subjected to alkaline conditioning on Day 1 in Example 2 was used in pretreatment, as described by Foody, U.S. Pat. No. 4,461,648. The results were compared with those obtained for wheat straw that has not been subjected to alkaline conditioning. The results are shown in Table 10. In all conditions tested, the xylose yield is significantly higher for alkaline conditioned straw than for raw straw. The raw straw requires a longer time to reach the optimum xylose yield.

TABLE 10
Pretreatment of raw and alkaline conditioned wheat straw

| | |
|---|---|
| Time (sec) | Xylose yield (%) |

| Pretreatment | Actual | Kinetic | Raw | Alkaline |
|---|---|---|---|---|
| condition | time t | time t* | straw | conditioned |
| 200° C. pH 1.5 | 64 | 64 | 81.7 | 87.5 |
| 190° C. pH 1.5 | 104 | 63 | 80.7 | 87.7 |
| 190° C. pH 2.0 | 227 | 137 | 58.8 | 85.9 |
| 190° C. pH 2.3 | 366 | 221 | 40.1 | 85.4 |
| 180° C. pH 2.0 | 380 | 139 | 54.3 | 84.9 |
| 170° C. pH 1.5 | 292 | 65 | 76.4 | 86.6 |
| 170° C. pH 2.0 | 639 | 142 | 48.7 | 85.9 |
| 170° C. pH 2.3 | 1040 | 230 | 31.7 | 85.9 |

### Example 7

### Enzymatic Hydrolysis of Pretreated, Conditioned Wheat Straw

The alkaline conditioned, pretreated wheat straw prepared as set out in Example 4 on Day 1 was subjected to enzymatic hydrolysis by cellulose in laboratory and large scale hydrolysis reactors.

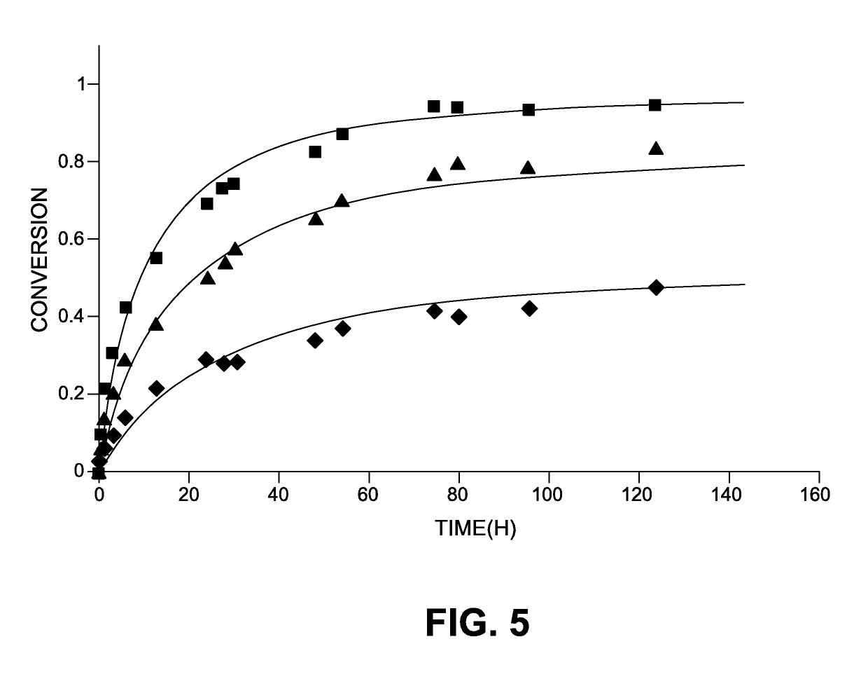

In the laboratory hydrolysis, the material conditioned on Day 1 and pretreated was added to 250 mL shake flasks. The hydrolysis slurries were made to 5% cellulose to a total volume of 100 mL and were adjusted to pH 5.0 using 50 mM sodium citrate buffer. The flasks were preheated to 50° C. prior to enzyme addition. The cellulase enzyme was made by Trichoderma longibrachiatum in submerged liquid culture fermentation, as described by White and Hindle, U.S. Pat. No. 6,015,703. The enzyme dosages were 5.3, 15.1, and 31.3 mg protein per gram cellulose. The flasks were incubated at 250 rpm and sampled periodically for glucose concentration. The results from Day 1 are shown in FIG. 5.

The enzymatic hydrolysis of the conditioned, pretreated straw achieved a cellulose conversion of over 90% with a dosage of 31.3 mg protein per gram cellulose.

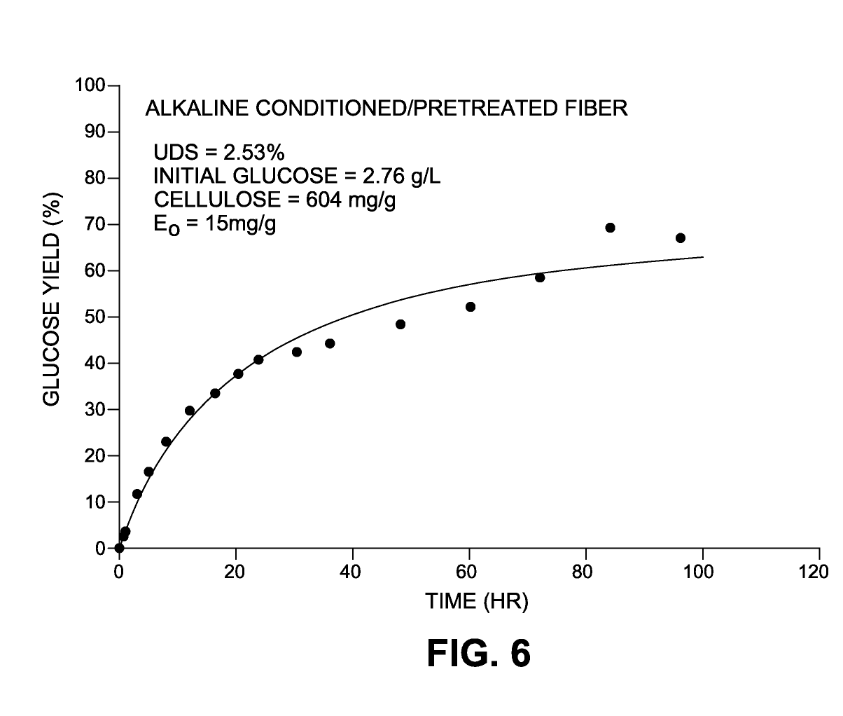

A further hydrolysis of the pretreated, conditioned wheat straw was carried out with a slurry of 700 liters volume in an agitated vessel. The hydrolysis was carried out at a cellulose concentration of 1.5% with an enzyme dosage of 15 mg protein per gram cellulose. The results shown in FIG. 6 indicate that a glucose yield approaching 70% was achieved at the end of the time course.

### Example 8

### Fermentation of Conditioned Versus Non-Conditioned Hydrolyzate Sugars

Twenty liters of alkaline conditioned, pretreated, hydrolyzed wheat straw slurry prepared in Example 6 was collected. The hydrolyzate was concentrated 2-fold by evaporation using a Heidolph™ evaporator, which removed a significant portion of the acetic acid from the slurry. The concentrated hydrolyzate was used for fermentability experiments.

For the fermentability experiments, the hydrolyzate sugars were tested; conventional hydrolyzate sugars made with pretreatment and enzymatic hydrolysis in the absence of alkaline conditioning were included as a control. All sugar hydrolyzates contained 200 mM MES (2 (N-morpholino) ethanesulfonic acid) buffer to maintain the pH at 5.5 during fermentation. Four cycles (3 recycles) were tested to determine if alkaline conditioning resulted in a loss of nutrients that could only be observed after multiple cycles. The fermentations were set up with 22.5 g/L Saccharomyces cerevisiae cells, pH 5.5, 160 rpm, 30° C. and were run for 21-23 hours.

Table 11 is a summary of the fermentability experiments. Yields to ethanol and xylose conversion were identical for sugar hydrolyzates made with and without alkaline conditioning prior to pretreatment. However, fermentation rates were faster for conditioned hydrolyzates due to the reduction of acetic acid concentration observed with conditioning the wheat straw fibre.

TABLE 11
Fermentation of conditioned and conventional sugars

| | Conventional hydrolyzate | | | Conditioned | | |
|---|---|---|---|---|---|---|
| | Ethanol | | | Ethanol | | |
| | yield | Xylose | Rate (g | yield | Xylose | Rate (g |
| | (mol/ | consumed | ethanol/g | (mol/ | consumed | ethanol/g |
| Cycle | mol) | (%) | cells/h) | mol) | (%) | cells/h) |
| 1 | 0.44 | 98.3 | 0.042 | 0.43 | 98.6 | 0.061 |
| 2 | 0.44 | 97.7 | 0.040 | 0.44 | 98.1 | 0.057 |
| 3 | 0.42 | 98.2 | 0.039 | 0.44 | 98.6 | 0.054 |
| 4 | 0.43 | 97.9 | 0.037 | 0.44 | 96.4 | 0.055 |

1. A process for the conversion of a lignocellulosic feedstock to a fermentation product, the process comprising the steps of:
(i) treating the lignocellulosic feedstock with alkali at a pH of between about 8.0 and about 12.5 so as to dissolve acetyl groups present on said lignocellulosic feedstock, while converting less than about 10% of the xylan present in the lignocellulosic feedstock to xylose and less than about 10% of the cellulose to glucose, thereby producing an alkali conditioned feedstock;
(ii) pretreating the alkali conditioned feedstock with acid at a temperature of about 160° C. to about 250° C., at a pH of about 0.5 to about 2.5 for about 0.5 to about 10 minutes so as to hydrolyze about 80 to 100% of the xylan and about 3 to about 15% of the cellulose to produce an acid pretreated feedstock comprising cellulose;
(iii) adding cellulase enzymes to the acid pretreated feedstock to hydrolyze the cellulose to glucose; and
(iv) fermenting the glucose to the fermentation product.

2. A process for producing a pretreated lignocellulosic feedstock, the process comprising the steps of:
(i) treating the lignocellulosic feedstock with alkali at a pH of between about 8.0 and about 12.5 so as to dissolve acetyl groups present on said lignocellulosic feedstock, while converting less than about 10% of the xylan present in the lignocellulosic feedstock to xylose and less than about 10% of the cellulose to glucose, thereby producing an alkali conditioned feedstock; and
(ii) pretreating the alkali conditioned feedstock to produce the pretreated lignocellulosic feedstock at combinations of pH and t* bounded by a region in a semi-log plot of t* versus pH, which bounded region has four vertices with numerical values of pH=0.5, t*=11 sec;
pH=0.5, t*=16 sec;
pH=2.5, t*=257 sec; and
pH=2.5, t*=380 sec
which vertices are connected by straight lines and wherein
t*=t×2(T−200)/13.9
t*=kinetic time (seconds)
t=actual pretreatment time (seconds) and
T=temperature, ° C.

3. The process of claim 1, wherein the temperature of the feedstock during the step of treating with alkali is between about 70° C. and about 120° C.

4. The process of claim 1, wherein the duration of the step of treating with alkali is between about 5 minutes and about 90 minutes.

5. The process of claim 1, wherein less than about 25% of the lignin (w/w) is dissolved during the step of treating with alkali.

6. The process of claim 1, wherein the acid used in the pretreating is sulfuric acid, sulfurous acid, sulfur dioxide or a combination thereof.

7. The process of claim 6, wherein the acid used in pretreating is sulfuric acid.

8. The process of claim 1, further comprising a step of washing the conditioned feedstock with water to produce a washed, conditioned feedstock.

9. The process of claim 1, wherein the fermentation product is ethanol.

10. The process of claim 2, wherein the vertices have numerical values of
pH=0.5, t*=11 sec;
pH=0.5, t*=14 sec;
pH=2.5, t*=257 sec; and
pH=2.5, t*=330 sec.

11. The process of claim 2, wherein the vertices have numerical values of
pH=1.5, t*=50 sec;
pH=1.5, t*=90 sec;
pH=2.5, t*=257 sec; and
pH=2.5, t*=330 sec.

12. A process for producing an acid pretreated lignocellulosic feedstock comprising cellulose, the process comprising the steps of:
(i) treating the lignocellulosic feedstock with alkali at a pH of between about 8.0 and about 12.5, at a temperature of about 70° C. to about 120° C. and for a time period of between about 5 minutes and about 90 minutes so as to dissolve acetyl groups present on said lignocellulosic feedstock, while converting less than about 10% of the xylan present in the lignocellulosic feedstock to xylose and less than about 10% of the cellulose to glucose, thereby producing an alkali conditioned feedstock; and
(ii) pretreating the alkali conditioned feedstock with acid at a temperature of about 160° C. to about 220° C., at a pH of about 1.5 to about 2.5 for about 0.5 to about 10 minutes so as to hydrolyze about 80 to 100% of the xylan and about 3 to about 15% of the cellulose to produce the acid pretreated feedstock comprising cellulose.

13. A process for producing an acid pretreated lignocellulosic feedstock, the process comprising the steps of:
(i) leaching the lignocellulosic feedstock with an aqueous solution to remove at least potassium salts from said lignocellulosic feedstock and without significantly hydrolyzing xylan and cellulose, thereby producing a leached feedstock and leachate;
(ii) removing the leachate from leached feedstock, said leachate comprising at least potassium salt;
(iii) concentrating the leachate comprising the potassium salt to produce concentrated leachate;
(iv) treating the lignocellulosic feedstock with alkali comprising concentrated leachate at a pH of between about 8.0 and about 12.5 so as to dissolve acetyl groups present on said lignocellulosic feedstock, while converting less than about 10% of the xylan present in the lignocellulosic feedstock to xylose and less than about 10% of the cellulose to glucose, thereby producing an alkali conditioned feedstock; and
(v) pretreating the alkali conditioned feedstock with acid at a temperature of about 160° C. to about 250° C., at a pH of about 0.5 to about 2.5 for about 0.5 to about 10 minutes so as to hydrolyze about 80 to 100% of the xylan and about 3 to about 15% of the cellulose to produce the acid pretreated feedstock.
